(19) United States
(12) Patent Application Publication
(10) Pub. No.: US 2016/0307386 A1
(43) Pub. Date: Oct. 20, 2016

(54) COIN PROCESSING DEVICE

(71) Applicant: NIPPON CONLUX CO., LTD., Sakado-shi (JP)

(72) Inventors: Naoki KATAGIRI, Sakado-shi (JP); Ryoji KATAGIRI, Sakado-shi (JP); Masaaki YAMAKI, Sakado-shi (JP)

(73) Assignee: NIPPON CONLUX CO., LTD., Sakado-shi (JP)

(21) Appl. No.: 15/101,773

(22) PCT Filed: Sep. 30, 2014
(86) PCT No.: PCT/JP2014/076114

§ 371 Date: Jun. 3, 2016

(30) Foreign Application Priority Data
Dec. 5, 2013 (JP) 2013-252147

(51) Int. Cl. G07D 1/06; G07D 9/00

(52) U.S. Cl. CPC G07D 1/06; G07D 9/00

(57) ABSTRACT

A coin processing device includes a coin discriminating unit, a coin distributing unit, plural coin tubes, and a coin delivering unit that delivers coins that have been housed in the coin tubes, by delivering operation of pulling out by a payout slide. For specific denominations, a two-coin delivering coin tube and one-coin delivering coin tubes are provided. In a normal state, the coin distributing unit distributes coins that have been inserted, to at least one of the coin tubes, the at least one having the coin housing number smaller, and the coin delivering unit delivers the coins to minimize the number of times of the delivering operation. In a change-shortage state, the coin distributing unit preferentially distributes the coins that have been inserted, to the one-coin delivering coin tubes, and the coin delivering unit performs delivery from only the two-coin delivering coin tube as much as possible.

### TECHNICAL FIELD

The present invention relates to a coin processing device to be installed in a vending machine, a money changer, a fare adjustment machine, a ticket-vending machine, or a servicing apparatus (hereinafter, referred to as a “vending machine or the like”).

### BACKGROUND ART

Conventionally, a coin processing device that distinguishes whether inserted coins are genuine, sorts and houses, each denomination, inserted coins that have been determined as genuine coins, and further delivers the coins that have been sorted and housed, in response to an amount of change or the like, is installed inside a vending machine or the like. FIG. 13 is a schematic view of this type of coin processing device.

The coin processing device 1 mainly includes a coin sorting device 2 for distinguishing whether inserted coins are genuine and distributing the inserted coins each denomination, and a coin delivering device 3 for housing, each denomination, the inserted coins that have been distributed by the coin sorting device 2, selecting and delivering coins from the inserted coins that have been housed, in response to an amount of change or the like. The coin sorting device 2 includes a coin discriminating unit 4 for distinguishing whether the inserted coins are genuine and denominations, and a coin distributing unit 5 for distributing, each denomination, coins that have been determined as genuine coins by the coin discriminating unit 4. The coin delivering device 3 includes a plurality of coin tubes 6 that houses, each denomination, the coins that have been distributed each denomination by the coin sorting device 2, and a coin delivering unit 7 for selecting and delivering coins from the plurality of coin tubes 6 in response to an amount of change or the like. As the coin delivering unit 7, the following unit has been widely adopted. The coins that have been housed in the coin tubes 6 are pulled out one by one, from slit holes open at bottom portions of the coin tubes 6, by a sliding member referred to as a payout slide. Thus, the coins are delivered. The payout slide includes coin housing holes provided at portions corresponding to the bottom portions of the respective coin tubes 6. Coins that have fitted into the coin housing holes are pulled out. The coin delivering unit 7 selectively performs support of lower surfaces of the coins that have fitted into the coin housing holes of the payout slide, and release of the support, by slide members referred to as change slides. Therefore, delivery and non-delivery of coins that have been pulled out, are controlled.

### CITATION LIST

### Patent Literature

Patent Literature 1: JP 07-262426 A

Patent Literature 2: JP 2013-37424 A

### SUMMARY OF INVENTION

### Technical Problem

In a coin processing device, there is a general demand that delivering processing of coins should be performed for as short a time as possible. A method of increasing delivering operation itself in speed can be thought in order to perform the delivering processing of coins for a short time. However, with the method of increasing the delivering operation itself in speed, a harmful effect, such as a coin jam, easily occurs. Therefore, it is difficult to get a considerable increase in speed.

An object of the present invention is to provide a coin processing device capable of increasing delivering processing of coins in speed without causing the above harmful effect.

### Solution to Problem

In order to solve the above problems, a coin processing device of claim 1 includes: a coin discriminating unit configured to discriminate denominations of coins that have been inserted; a coin distributing unit configured to distribute the coins that have been discriminated by the coin discriminating unit, each denomination; a plurality of coin tubes for housing the coins that have been distributed by the coin distributing unit, each denomination; and a coin delivering unit configured to deliver the coins that have been housed in the coin tubes, by delivering operation of pulling out by a payout slide. For specific denominations, a two-coin delivering coin tube from which two coins are pulled out in one time of the delivering operation, and a one-coin delivering coin tube from which one coin is pulled out in one time of the delivering operation, are provided. In a normal state where the coin housing number of the one-coin delivering coin tube is sufficient, the coin distributing unit distributes the specific denomination coins that have been inserted, to at least one of the coin tubes, the at least one having the coin housing number smaller, and the coin delivering unit delivers the specific denomination coins from at least one of the coin tubes, the at least one being selected in order to minimize the number of times of the delivering operation. In a change-shortage state where the coin housing number of the one-coin delivering coin tube is insufficient, the coin distributing unit preferentially distributes the specific denomination coins that have been inserted, to the one-coin delivering coin tube, and the coin delivering unit delivers as many of the specific denomination coins as possible from only the two-coin delivering coin tube.

A coin processing device of claim 2 includes: a coin discriminating unit configured to discriminate denominations of coins that have been inserted; a coin distributing unit configured to distribute the coins that have been discriminated by the coin discriminating unit, each denomination; a plurality of coin tubes for housing the coins that have been distributed by the coin distributing unit, each denomination; and a coin delivering unit configured to deliver the coins that have been housed in the coin tubes, by delivering operation of pulling out by a payout slide. For specific denominations, a two-coin delivering coin tube from which two coins are pulled out in one time of the delivering operation, and a one-coin delivering coin tube from which one coin is pulled out in one time of the delivering operation, are provided. A two-coin delivering use mode in which the coin distributing unit performs distribution of coins to the two-coin delivering coin tube and the coin delivering unit performs delivery of coins from the two-coin delivering coin tube, and a two-coin delivering non-use mode in which the coin distributing unit does not perform distribution of coins to the two-coin delivering coin tube and the coin delivering unit does not perform delivery of coins from the two-coin delivering coin tube, are selectively performed. After power is turned on, the two-coin delivering non-use mode is selected, and when a command for delivering two or more coins is received, a switch to the two-coin delivering use mode is performed.

A coin processing device of claim 3 is the coin processing device described in claim 1. The number of the one-coin delivering coin tube is two or more. In the normal state, the coin distributing unit preferentially distributes the specific denomination coins that have been inserted, to at least one of the one-coin delivering coin tubes, the at least one having the coin housing number smaller, and the coin delivering unit preferentially delivers the specific denomination coins from at least one of the one-coin delivering coin tubes, the at least one having the coin housing number larger. In the change-shortage state, the coin distributing unit preferentially distributes the specific denomination coins that have been inserted, to at least one of the one-coin delivering coin tubes, the at least one having the coin housing number larger, and the coin delivering unit preferentially delivers the specific denomination coins from at least one of the one-coin delivering coin tubes, the at least one having the coin housing number smaller.

A coin processing device of claim 4 is the coin processing device of claim 1 or 3, and further includes a coin detecting unit configured to detect whether the coin housing number of each of the coin tubes has been a predetermined number or less. In a case where the coin detecting unit has not detected that the coin housing number of at least one of the one-coin delivering coin tubes has been the predetermined number or less, the normal state is made. In a case where the coin detecting unit has detected that the coin housing numbers of all of the one-coin delivering coin tubes have been the predetermined number or less, the change-shortage state is made.

### Advantageous Effects of Invention

According to the present invention, delivering processing of coins can be increased in speed.

### BRIEF DESCRIPTION OF DRAWINGS

FIG. 1 is a block diagram of a coin processing device according to an embodiment of the present invention.

FIG. 2 is a schematic view of the coin processing device according to the embodiment of the present invention.

FIG. 3 is a flow chart of a flow of operation of the coin processing device according to the embodiment of the present invention.

FIG. 4 is a flow chart of a flow of distributing processing of the coin processing device according to the embodiment of the present invention.

FIG. 5 is a flow chart of a flow of 500W (50W) distributing processing of the coin processing device according to the embodiment of the present invention.

FIG. 6 is a flow chart of a flow of 100W distributing processing of the coin processing device according to the embodiment of the present invention.

FIG. 7 is a flow chart of a flow of delivering processing of the coin processing device according to the embodiment of the present invention.

FIG. 8 is a flow chart of a flow of delivering-tube determining processing of the coin processing device according to the embodiment of the present invention.

FIG. 9 is a flow chart of a flow of 500W (50W) delivering-tube determining processing of the coin processing device according to the embodiment of the present invention.

FIG. 10 is a flow chart of a flow of 100W delivering-tube determining processing of the coin processing device according to the embodiment of the present invention.

FIG. 11 is a flow chart of a flow of 100W delivering-tube determining processing of the coin processing device according to the embodiment of the present invention in a normal state.

FIG. 12 is a flow chart of a flow of 100W delivering-tube determining processing of the coin processing device according to the embodiment of the present invention in a change-shortage state.

FIG. 13 is a schematic view of a conventional coin processing device.

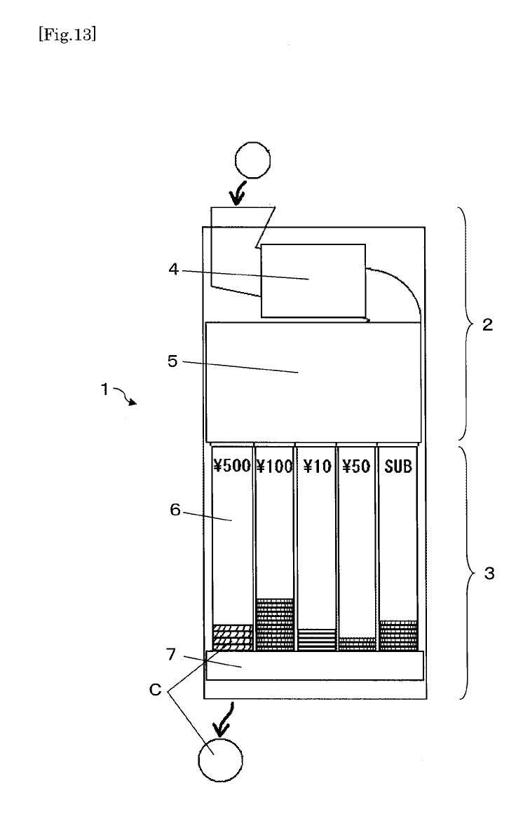

### DESCRIPTION OF EMBODIMENTS

One embodiment of the present invention will be described below based on the drawings.

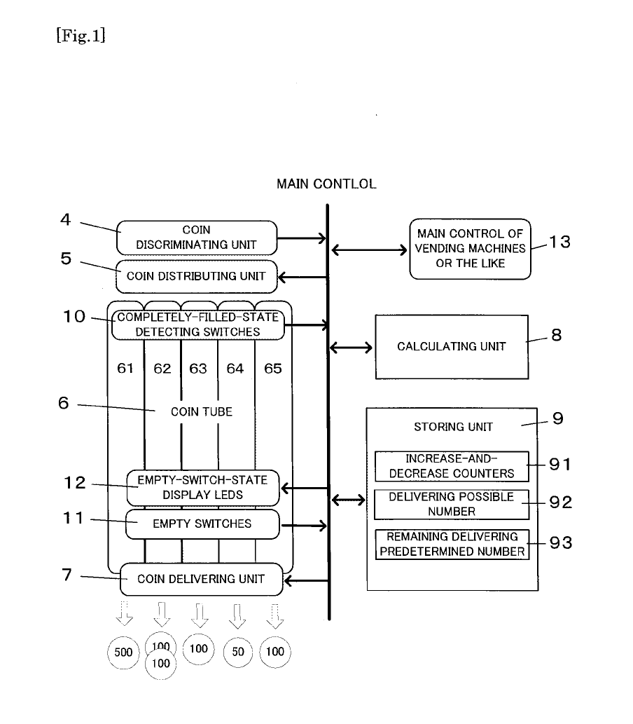

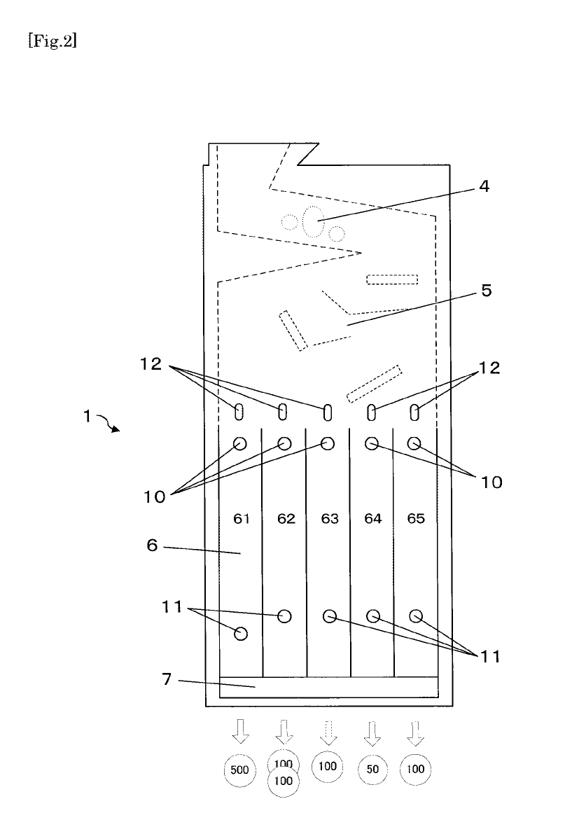

FIG. 1 is a block diagram of a coin processing device 1 according to the embodiment of the present invention. FIG. 2 is a schematic view of the coin processing device 1 according to the embodiment of the present invention, and schematically illustrates a section of the coin processing device 1. A structure of the coin processing device 1 according to the embodiment is the same as a structure of the conventional coin processing device described above except portions to be described below. Thus, members in constituent members according to the embodiment, substantially the same as constituent members in the above conventional coin processing device, are denoted with the same reference signs, and the detailed descriptions thereof will be omitted.

The coin processing device 1 includes a coin discriminating unit 4, a coin distributing unit 5, five coin tubes 6, a coin delivering unit 7, a calculating unit 8, and a storing unit 9. The coin delivering unit 7 includes one payout slide having five coin housing holes corresponding to the respective coin tubes 6, provided thereto. The payout slide is pulled out so that at least one coin that has been housed in the coin housing holes is delivered. The coin tubes 6 each include a completely-filled-state detecting switch 10 that is a sensor for detecting whether the corresponding coin tube 6 has been completely filled with coins that have been housed, and an empty switch 11 that is a sensor for detecting whether the number of coins that has been housed in the corresponding coin tube 6 has been a predetermined number or less. The coin processing device 1 includes increase-and-decrease counters 91 of the respective coin tubes 6 in the storing unit 9 in order to grasp the number of coins that has been housed in each of the coin tubes 6. The increase-and-decrease counters 91 each have an initial value of zero when power is turned on or when attachment or detachment of the coin tubes 6 has been recognized. When coins have been distributed to the respective coin tubes 6, the increase-and-decrease counters are added. When coins have been delivered from the respective coin tubes 6, the increase-and-decrease counters are subtracted. The storing unit 9 in the coin processing device 1 includes a region for storing delivering possible numbers 92 and remaining delivering predetermined numbers 93 of the respective coin tubes 6 necessary for processing after a refund command has been received from a main control 13 of a vending machine or the like. Each of the delivering possible numbers 92 is the number of coins that can be securely delivered from each of the coin tubes 6 and has been recognized by the coin processing device 1. When the power of the device main body is turned on or when the attachment and detachment of the coin tubes 6 has been recognized, in a case where each of the empty switches 11 has detected that the number of coins housed in each of the coin tubes 6 has been the predetermined number or less, a count of each of the delivering possible numbers 92 begins with zero. In a case where each of the empty switch 11 has not yet detected that the number of coins housed in each of the coin tubes 6 has been the predetermined number or less, measurement begins with the predetermined number plus 1. Basically, addition is made when coins have been distributed to the respective coin tubes 6. Subtraction is made when coins have been delivered from the respective coin tubes 6. Note that, while each of the empty switches 11 has not detected that the number of coins housed in each of the coin tubes 6 has been the predetermined number or less, each of the delivering possible numbers 92 is not subtracted so as not to be the predetermined number or less. When each of the completely-filled-state detecting sensors 10 detects a completely filled state, each of the delivering possible numbers 92 is made to be a completely-filled-state number. With each of the delivering possible numbers 92, the number of coins that can be securely delivered from the respective coin tubes 6, namely, the minimal housing number of coins housed in the respective coin tubes 6 can be grasped. The above configuration is the same as the configuration of the conventional coin processing device.

From the left side in FIGS. 1 and 2, the five coin tubes 6 in the coin processing device 1 indicate a 500W tube 61 that houses 500 won coins, a 100W two-coin delivering tube 62 that houses 100 won coins, a 100W one-coin delivering tube A 63 that houses 100 won coins, a 50W tube 64 that houses 50 won coins, and a 100W one-coin delivering tube B 65 that houses 100 won coins. Here, the 100W two-coin delivering tube 62 is a two-coin delivering coin tube that delivers two coins upon one time of delivering operation (one return of operation of pulling out and restoring the payout slide). A point of using the two-coin delivering coin tube is the technical idea newly introduced by the applicants of the present invention, and is an original configuration. During one time of the delivering operation (the one return of operation of pulling out and restoring the payout slide), delivering two coins at once from one coin tube can be achieved as follows: A height of an inner wall of a coin housing hole of the payout slide is made so as to have a height of two coins, the coin housing hole corresponding to the coin tube. The coin housing hole houses two coins. The two coins that have been housed in the coin housing hole are delivered by pulling out the payout slide at once. As a method of making the height of an inner wall of a coin housing hole of the payout slide have a height of two coins, for example, it can be thought that a standing wall is provided around the coin housing hole of the payout slide. Except the 100W two-coin delivering tube 62, the four coin tubes 61, 63, 64, and 65 deliver one coin during delivering operation at once (one return of operation of pulling out and restoring the payout slide), similarly to the conventional coin tubes.

In this manner, the coin processing device 1 uses the two-coin delivering coin tube (the 100W two-coin delivering tube 62) and the one-coin delivering coin tubes (the 100W one-coin delivering tube A 63, the 100W one-coin delivering tube B 65) together for 100 won coins. The applicants of the present invention have found that problems to be described below occur in this type of configuration, and solutions to the problems.

During delivering operation at once, the two-coin delivering coin tube 62 can deliver two coins, but cannot deliver one coin. Thus, when no coins have been housed in the one-coin delivering coin tubes 63 and 65, odd-number delivery cannot be handled. Therefore, when no coins have been housed in the one-coin delivering coin tubes 63 and 65, and even in a case where a number of coins have been housed in the two-coin delivering coin tube 62, no 100 won coin cannot be delivered as change. That is, when no coins have been housed in the one-coin delivering coin tubes 63 and 65, the coin processing device 1 needs to make the delivering possible number zero regardless of whether coins are present in the two-coin delivering coin tube 62

Due to the above problem, in a case where the two-coin delivering coin tube 62 and the one-coin delivering coin tubes 63 and 65 are used together, it is necessary to avoid a state where only the two-coin delivering coin tube 62 has housed coins and the one-coin delivering coin tubes 63 and 65 have housed no coins. Therefore, as a solution to the problem, it can be thought that coins that have been inserted are preferentially distributed to the one-coin delivering coin tube 62 and change is preferentially delivered from the two-coin delivering coin tube 62. However, with this method, a state where no coins have been housed in the two-coin delivering coin tube 62 and a number of coins have been housed in the one-coin delivering coin tubes 63 and 65, easily occurs. The state causes the number of times of delivering operation necessary to increase, and causes delivery of the coins to decrease in speed.

Therefore, the coin processing device 1 according to the embodiment of the present invention performs different processing in a case where the one-coin delivering coin tubes 63 and 65 have housed a number of coins for change and in a case where the one-coin delivering coin tubes 63 and 65 have not sufficiently housed coins for change in terms of a determination of which of the coin tubes 6 are distributing destinations of coins that have been inserted and a determination of which of the coin tubes 6 performs delivery of coins. The coin processing device 1 according to the present embodiment makes a determination of whether the coin housing numbers of the one-coin delivering coin tubes 63 and 65 are sufficient, based on output of the empty switches 11 as coin detecting units. In a case where each of the empty switches 11 has not detected that the number of coins that has been housed has been the predetermined number or less in any one of the one-coin delivering coin tubes (the 100 W one-coin delivering tube A 63 or the 100W one-coin delivering tube B 65), the coin housing numbers of the one-coin delivering coin tubes 63 and 65 are determined to be sufficient. In a case where each of the empty switches 11 has detected that the number of coins that has been housed has been the predetermined number or less in each of the one-coin delivering coin tubes (the 100 W one-coin delivering tube A 63 and the 100W one-coin delivering tube B 65), the coin housing numbers of the one-coin delivering coin tubes 63 and 65 are determined to be insufficient. The predetermined number of the empty switches 11 is set to be normally, approximately 10 for 100 won coins.

First, in a case where coins for change have been sufficiently housed in the one-coin delivering coin tubes 63 and 65 (a normal state), the coin processing device 1 performs distribution of coins that have been inserted so that the coin housing number of each of the coin tubes 6 is equivalent. The coin processing device 1 performs delivery of coins so that the number of times of delivering operation (one return of operation of pulling out and restoring the payout slide) is minimized. Specifically, the coin processing device 1 performs the distribution of coins that have been inserted so that the coins that have been inserted is housed in one of the coin tubes 6 that has the minimal coin housing number. The coin processing device 1 performs the delivery of coins from the two-coin delivering coin tube 62, preferentially, in the two-coin delivering coin tube 62 and the one-coin delivering coin tubes 63 and 65, and preferentially performs the delivery of coins from one of the one-coin delivering coin tubes 63 and 65, the one being larger than the other in terms of the coin housing number.

Next, in a case where coins for change have not been sufficiently housed in the one-coin delivering coin tubes 63 and 65 (a change-shortage state), the coin processing device 1 intensively performs distribution of coins that have been inserted, with respect to the one-coin delivering coin tubes 63 and 65. The coin processing device 1 performs delivery of coins from the two-coin delivering coin tube 62 as much as possible even when the number of times of delivering operation increases. Specifically, the coin processing device 1 performs the distribution of coins that have been inserted, to one of the one-coin delivering coin tubes 63 and 65, the one being larger than the other in terms of the coin housing number. The coin processing device 1 performs the delivery of coins from only the two-coin delivering coin tube 62 as much as possible, and performs delivery of coins from the one-coin delivering coin tube 63 and 65 only when the delivering number is odd. The delivery of coins is preferentially performed from one of the one-coin delivering coin tubes 63 and 65, the one being smaller than the other in terms of the coin housing number. Here, the reason why the distribution of coins is preferentially performed to the one larger than the other in terms of the coin housing number and the delivery of coins is performed from the one smaller than the other in terms of the coin housing number, is because an escape from the change-shortage state is achieved as fast as possible and the normal state is made.

With the above configuration, a state where only the two-coin delivering coin tube 62 has housed change, can be avoided as much as possible and a period during which delivery is performed from the two-coin delivering coin tube 62 and the one-coin delivering coin tubes 63 and 65, simultaneously, can be prolonged.

The determination of which of the coin tubes 6 are distributing destinations of coins that have been inserted and the determination of which of the coin tubes 6 performs delivery of coins in the coin processing device 1, have been described above. The consideration is required for not only the distribution of coins by the coin processing device 1 but also replenishment of change by a worker who replenishes the change. That is, upon replenishing the change by the worker, in order to avoid the change-shortage state, the worker is required to replenish coins until a state where the empty switches 11 in the 100W one-coin delivering tubes 63 and 65 have not detected that the number of coins housed has been the predetermined number or less, is acquired. However, generally, the worker cannot determine how many coins should be replenished in order to acquire the state where the empty switches 11 have not detected that the number of coins housed has been the predetermined number or less. Therefore, in the coin processing device 1, each of the coin tubes 6 includes an empty-switch-state display LED 12 provided thereto as a display unit for displaying a state of each of the empty switches 11. With the display unit, the worker can ascertain a detecting state of each of the empty switches 11.

A case where delivery from the two-coin delivering coin tube 62 is not available, such as a case where prices of products sold by a vending machine or the like including the coin processing device 1 installed therein are only 900 wons, is anticipated. Therefore, in the coin processing device 1, the worker can mutually switch between a setting for using the two-coin delivering coin tube 62 and a setting for not using the two-coin delivering coin tube 62. With the setting for not using the two-coin delivering coin tube 62, the coin processing device 1 does not perform distribution of coins to the two-coin delivering coin tube 62 and does not perform delivery of coins from the two-coin delivering coin tube 62. Furthermore, an automatic setting capable of automatically setting the setting for using the two-coin delivering coin tube 62 and the setting for not using the two-coin delivering coin tube 62, is available in the coin processing device 1. With the automatic setting, after the power is turned on, the coin processing device 1 first operates with the setting for not using the two-coin delivering coin tube 62. After that, when receiving at least one delivering command for two coins or more for change, the coin processing device 1 switches to the setting for using the two-coin delivering coin tube 62. With this configuration, the coin processing device 1 is capable of handling a case of a product price setting with which the two-coin delivering coin tube 62 cannot be used.

Next, a flow of the above processing performed in the coin processing device 1 according to the embodiment of the present invention, will be described.

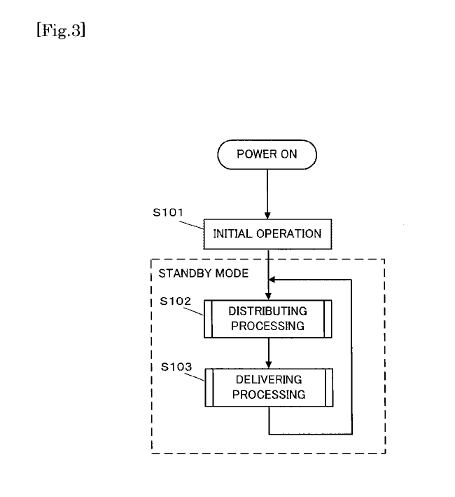

FIG. 3 is a flow chart of a flow of operation of the coin processing device 1 according to the embodiment of the present invention. When the power is turned on, the coin processing device 1 first performs initial operation (S101). After that, the coin processing device 1 becomes in a standby mode. When insertion of a coin is detected, the coin processing device 1 performs distributing processing (S102), and performs delivering processing when receiving a refund command from the main control 13 of the vending machine or the like (S103).

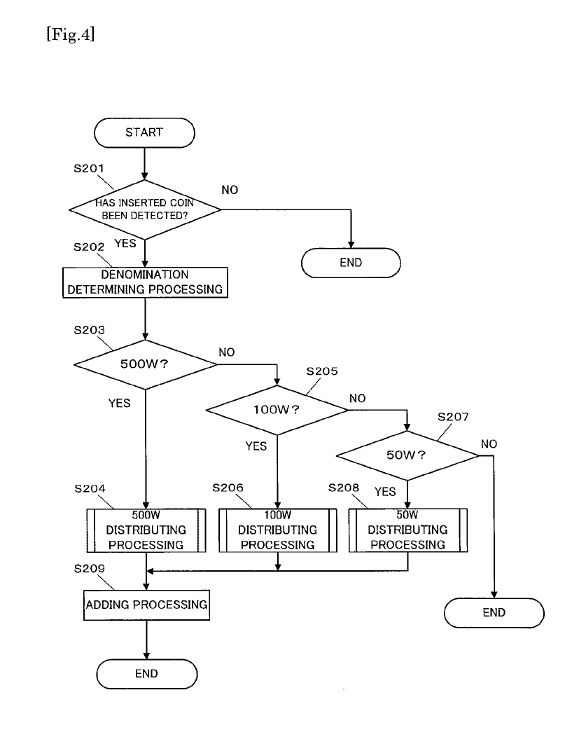

FIG. 4 is a flow chart of a flow of the distributing processing (S102) of the coin processing device 1 according to the embodiment of the present invention. During the distributing processing (S102), when detecting the insertion of a coin in the standby mode (S201), the coin processing device 1 performs denomination determining processing (S202). When the coin that has inserted is determined to be a 500 won coin (S203), 500W distributing processing is performed (S204). When the coin is determined to be a 100 won coin (S205), 100W distributing processing is performed (S206). When the coin is determined to be a 50 won coin (S207), 50W distributing processing is performed (S208). Finally, the coin processing device 1 performs adding processing, such as updates of the increase-and-decrease counters 91 and the delivering possible numbers 92, in response to the number of coins that have been distributed (S209).

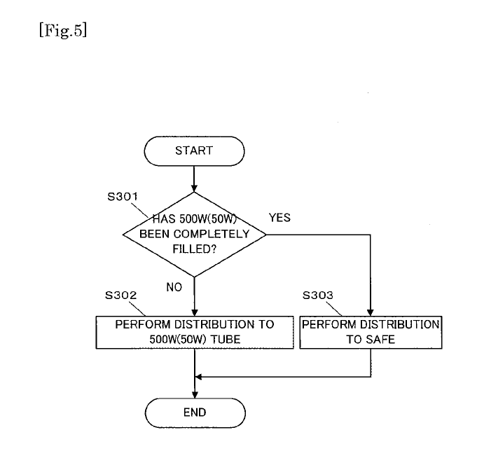

FIG. 5 is a flow chart of a flow of the 500W distributing processing (S204) of the coin processing device 1 according to the embodiment of the present invention. During the 500W distributing processing (S204), the coin processing device 1 determines whether the 500W tube 61 has been in a completely filled state (S301). In a case of the completely filled state, coins that have been inserted are distributed to a safe (S303). In a case of a non-completely filled state, the coins that have been inserted are distributed to the 500W tube 61 (S302). The 50W distributing process (S208) is performed similarly to the 500W distributing processing.

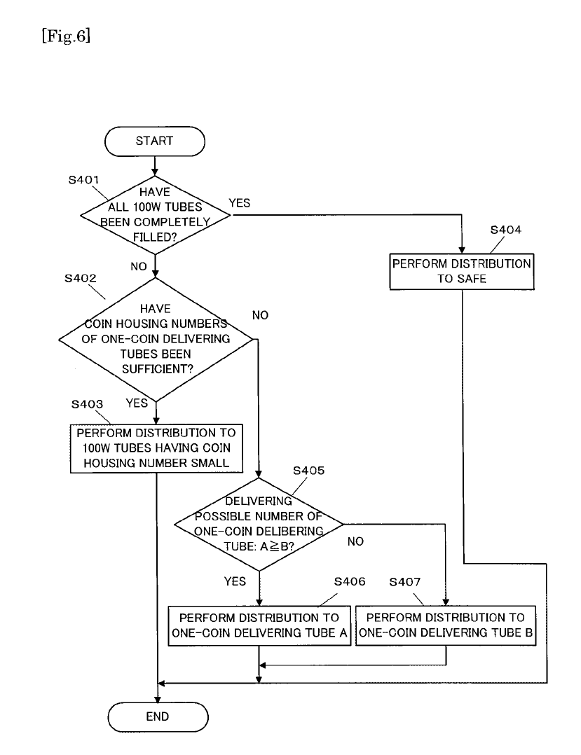

FIG. 6 is a flow chart of a flow of the 100W distributing processing (S206) of the coin processing device 1 according to the embodiment of the present invention. During the 100W distributing processing (S206), the coin processing device 1 first determines whether all of the 100W tubes (the 100W two-coin delivering tube 62, the 100W one-coin delivering tube A 63, and the 100W one-coin delivering tube B 65) have been completely filled (S401). In a case where all of the 100W tubes 62, 63, and 65 have been completely filled, the coin processing device 1 distributes the inserted coins to the safe (S404). Otherwise, the coin processing device 1 determines whether the coin housing numbers of the 100W one-coin delivering tubes (the 100W one-coin delivering tube A 63, the 100W one-coin delivering tube B 65) have been sufficient (S402). In a case where the coin housing numbers of the 100W one-coin delivering tubes 63 and 65 have been sufficient (a normal state), the coin processing device 1 distributes the coins that have been inserted, to the 100W tubes 62, 63, and 65 having the coin housing numbers small (S403). In a case where the coin housing numbers of the 100W one-coin delivering tubes 63 and 65 have been insufficient (a change-shortage state), the coin processing device 1 compares the delivering possible numbers 92 of the two 100W one-coin delivering tubes 63 and 65 (S405). Then, in a case where both of the values are the same or the value of the 100W one-coin delivering tube A 63 is larger, the coins are distributed to the 100W one-coin delivering tube A 63 (S406). In a case where the value of the 100W one-coin delivering tube B 65 is larger, the coins are distributed to the 100W one-coin delivering tube B 65 (S407). The determination of whether the coin housing numbers of the 100W one-coin delivering tubes 63 and 65 are sufficient, is performed based on the output of the corresponding empty switches 11 as described above. In a case where the empty switch 11 has not detected that the number of the coins that have been housed has been the predetermined number or less, in the 100W one-coin delivering tube A 63 or the 100W one-coin delivering tube B 65, the coin housing numbers of the 100W one-coin delivering tubes 63 and 65 are determined to be sufficient. In a case where the empty switches 11 have detected that the number of the coins that have been housed has been the predetermined number or less in both of the 100W one-coin delivering tube A 63 and the 100W one-coin delivering tube B 65, the 100W one-coin delivering tubes 63 and 65 are determined to be insufficient.

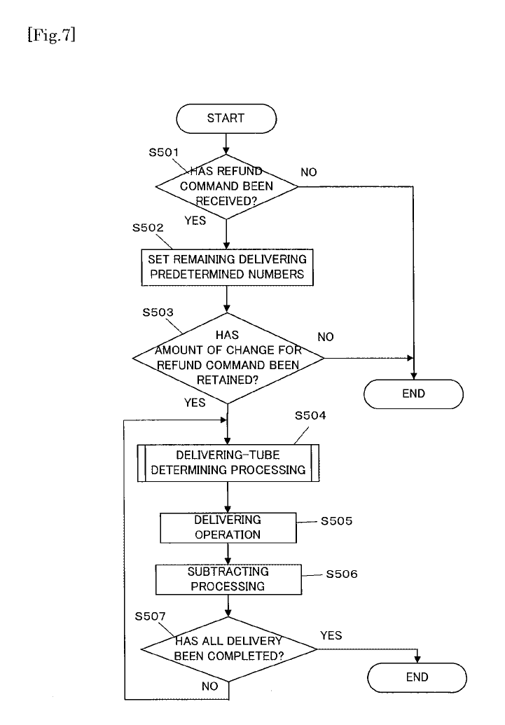

FIG. 7 is a flow chart of a flow of the delivering processing (S103) of the coin processing device 1 according to the embodiment of the present invention. The coin processing device 1 starts the delivering processing when receiving a refund command from the main control 13 of the vending machine or the like. The refund command includes denominations of coins to be delivered and the delivering predetermined numbers as details. During the delivering processing (S103), when receiving the refund command from the main control 13 of the vending machine or the like (S501), the coin processing device 1 sets the remaining delivering predetermined numbers 93 (S502), determines whether an amount of change for the refund command has been retained with reference to each of the delivering possible numbers 92 (S503). In a case where the amount of change for the refund command has not been retained, the coin processing device 1 completes the delivering processing. In a case where the amount of change for the refund command has been retained, delivering-tube determining processing is performed (S504). During the delivering-tube determining processing, at least one of coin tubes 6 with which delivery of coins is performed in the following one time of delivering operation (one return of operation of pulling out and restoring the payout slide) is determined. Next, the coin processing device 1 performs the one time of delivering operation (one return of operation of pulling out and restoring the payout slide). The coins are delivered from the at least one of coin tubes 6 that has been determined to be used for the delivery during the delivering-tube determining processing (S505). Next, the coin processing device 1 performs subtracting processing, such as updates of the increase-and-decrease counters 91 and the delivering possible numbers 92 in response to the number of coins that has been delivered (S506). Next, the coin processing device 1 determines whether all delivery has been completed (S507). In a case where all delivery has been completed, the delivering processing is completed. In a case where all delivery has not been completed yet, the coin processing device 1 performs delivering-tube determining processing for the remaining coins to be delivered (S504). After that, the same processing is repeated.

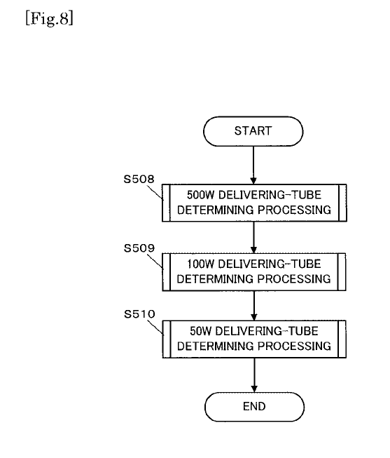

FIG. 8 is a flow chart of a flow of the delivering-tube determining processing (S504) of the coin processing device 1 according to the embodiment of the present invention. During the delivering-tube determining processing (S504), the coin processing device 1 successively performs 500W delivering-tube determining processing (S508) for determining the coin tube 6 with which delivery of 500 won coins is performed, 100W delivering-tube determining processing (S509) for determining the coin tubes 6 with delivery of 100 won coins is performed, and 50W delivering-tube determining processing (S510) for determining the coin tube 6 with which delivery of 50 won coins is performed.

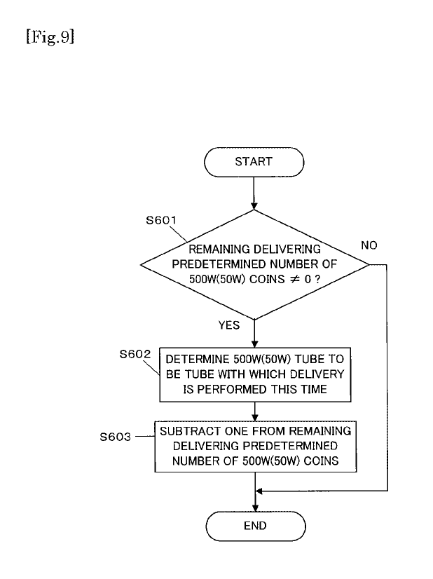

FIG. 9 is a flow chart of a flow of the 500W (50W) delivering-tube determining processing (S508) of the coin processing device according to the embodiment of the present invention. During the 500W delivering-tube determining processing (S508), the coin processing device 1 first determines whether the remaining delivering predetermined number 93 of 500 won coins has not been zero (S601). In a case where the remaining delivering predetermined number 93 of 500 won coins has been zero, the coin processing device 1 completes the 500W delivering-tube determining processing. In a case where the remaining delivering predetermined number 93 of 500 won coins has not been zero, the coin processing device 1 determines the 500W tube 61 to be a coin tube 6 with which delivery is performed in the following one time of delivering operation (S602). After that, the coin processing device 1 subtracts one from a value of the remaining delivering predetermined number 93 of 500 won coins so that an update is made (S603). The 500W delivering-tube determining processing is completed. The 50W delivering-tube determining processing (S510) is performed in a manner similar to the 500W delivering-tube determining processing.

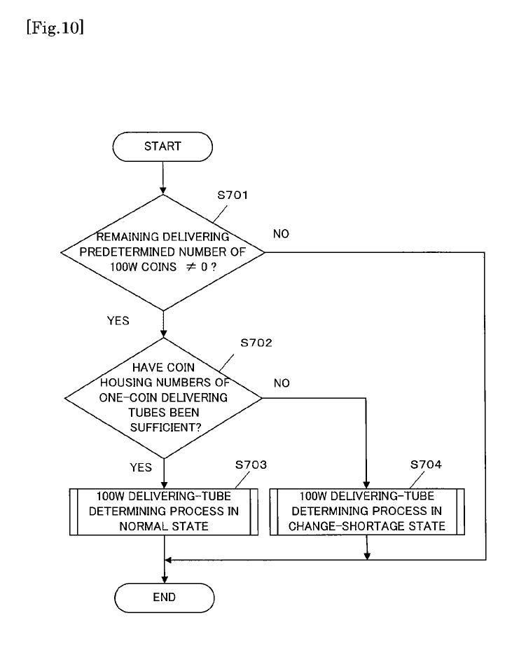

FIG. 10 is a flow chart of a flow of the 100W delivering-tube determining processing (S509) of the coin processing device 1 according to the embodiment of the present invention. During the 100W delivering-tube determining processing (S509), the coin processing device 1 first determines whether the remaining delivering predetermined number 93 of 100 won coins has not been zero (S701). In a case where the remaining delivering predetermined number 93 of 100 won coins has been zero, the coin processing device 1 completes the 100W delivering-tube determining processing. In a case where the remaining delivering predetermined number 93 of 100 won coins has not been zero, the coin processing device 1 determines whether the coin housing numbers of the 100W one-coin delivering tubes (the 100W one-coin delivering tube A 63, the 100W one-coin delivering tube B 65) have been sufficient (S702). In a case where the coin housing numbers of the 100W one-coin delivering tubes 63 and 65 have been sufficient (a normal state), the coin processing device 1 performs the 100W delivering-tube determining processing in the normal state (S703). In a case where the coin housing numbers of the 100W one-coin delivering tubes 63 and 65 have been insufficient (a change-shortage state), the coin processing device 1 performs the 100W delivering-tube determining processing in the change-shortage state (S704). Then, the 100W delivering-tube determining processing is completed. The determination of whether the coin housing numbers of the 100W one-coin delivering tubes 63 and 65 are sufficient, is performed based on the output of the corresponding empty switches 11 as described above. In a case where the empty switch 11 has not detected that the number of the coins that have been housed has been the predetermined number or less, in the 100W one-coin delivering tube A 63 or the 100W one-coin delivering tube B 65, the coin housing numbers of the 100W one-coin delivering tubes 63 and 65 are determined to be sufficient. In a case where the empty switches 11 have detected that the number of the coins that have been housed has been the predetermined number or less in both of the 100W one-coin delivering tube A 63 and the 100W one-coin delivering tube B 65, the 100W one-coin delivering tubes 63 and 65 are determined to be insufficient.

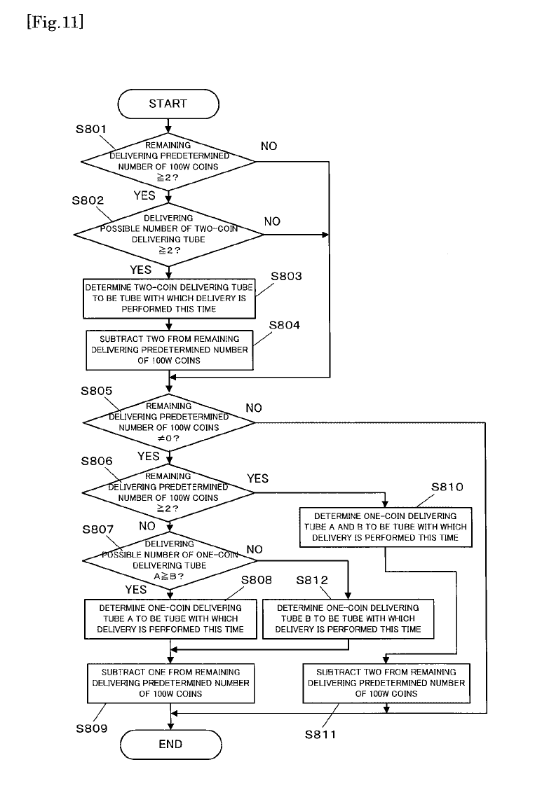

FIG. 11 is a flow chart of a flow of the 100W delivering-tube determining processing (S703) in the normal state of the coin processing device 1 according to the embodiment of the present invention. During the 100W delivering-tube determining processing in the normal state (S703), the coin processing device 1 first determines whether the remaining delivering predetermined number 93 of 100 won coins has been two or more (S801). In a case where the remaining delivering predetermined number 93 of 100 won coins has been two or more, the coin processing device 1 next determines whether the delivering possible number of the 100W two-coin delivering tube 62 has been two or more (S802). In a case where the remaining delivering predetermined number 93 of 100 won coins has been two or more and in a case where the delivering possible number 92 of the 100W two-coin delivering tube 62 has been two or more, the coin processing device 1 determines the 100W two-coin delivering tube 62 to be a coin tube 6 with which delivery is performed in the following one time of delivering operation (S803). The coin processing device 1 subtracts two from the remaining delivering predetermined number 93 of 100 won coins so that an update is made (S804). Meanwhile, in a case where the remaining delivering predetermined number 93 of 100 won coins has not been two or more, or in a case where the delivering possible number 92 of the 100W two-coin delivering tube 62 has not been two or more, the coin processing device 1 proceeds to the next processing without performing these pieces of processing.

Next, the coin processing device 1 determines whether the remaining delivering predetermined number 93 of 100 won coins has not been zero (S805). In a case where the remaining delivering predetermined number 93 of 100 won coins has been zero, the 100W delivering-tube determining processing in the normal state is completed. In a case where the remaining delivering predetermined number 93 of 100 won coins has not been zero, the coin processing device 1 determines whether the remaining delivering predetermined number 93 of 100 won coins has been two or more (S806). Here, in a case where the remaining delivering predetermined number 93 of 100 won coins has been two or more, the two 100W one-coin delivering tubes (the 100W one-coin delivering tube A 63, the 100W one-coin delivering tube B 65) are determined to be coin tubes 6 with which delivery of coins is performed in the following one time of delivering operation (one return of operation of pulling out and restoring the payout slide) (S810). Two is subtracted from the remaining delivering predetermined number 93 of 100 won coins so that an update is made (S811). Then, the 100W delivering-tube determining processing in the normal state is completed. Meanwhile, in a case where the remaining delivering predetermined number 93 of 100 won coins has not been two or more, namely, in a case where the remaining delivering predetermined number 93 of 100 won coins has been one, the coin processing device 1 compares the delivering possible numbers 92 of the two 100W one-coin delivering tubes (the 100W one-coin delivering tube A 63, the 100W one-coin delivering tube B 65) (S807). In a case where both of the values are the same or the value of the 100W one-coin delivering tube A 63 is larger, the 100W one-coin delivering tube A 63 is determined to be a coin tube 6 with which delivery of coins is performed in the following one time of delivering operation (one return of operation of pulling out and restoring the payout slide) (S808). In a case where the value of the 100W one-coin delivering tube B 65 is larger, the 100W one-coin delivering tube B 65 is determined to be a coin tube 6 with which delivery of coins is performed in the following one time of delivering operation (pulling out and restoring the payout slide) (S812). Finally, the coin processing device 1 subtracts one from the value of the remaining delivering predetermined number 93 of 100 won coins so that an update is made (S809). Then, the 100W delivering-tube determining processing in the normal state is completed.

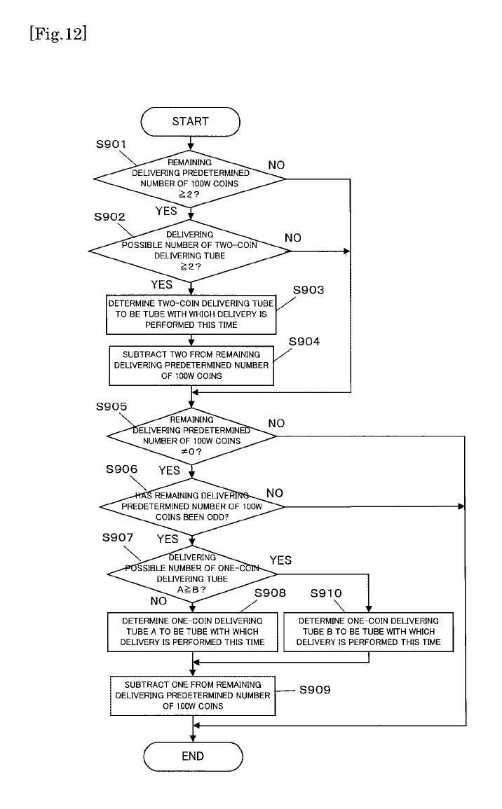

FIG. 12 is a flow chart of a flow of the 100W delivering-tube determining processing in the change-shortage state (S704) of the coin processing device 1 according to the embodiment of the present invention. During the 100W delivering-tube determining processing in the change-shortage state (S704), the coin processing device 1 first determines whether the remaining delivering predetermined number 93 of 100 won coins has been two or more (S901). In a case where the remaining delivering predetermined number 93 of 100 won coins has been two or more, the coin processing device 1 next determines whether the delivering possible number 92 of the 100W two-coin delivering tube 62 has been two or more (S902). In a case where the remaining delivering predetermined number 93 of 100 won coins has been two or more and in a case where the delivering possible number 92 of the 100W two-coin delivering tube 62 has been two or more, the coin processing device 1 determines the 100W two-coin delivering tube 62 to be a coin tube 6 with which delivery is performed in the following one time of delivering operation (S903). The coin processing device 1 subtracts two from the remaining delivering predetermined number of 100 won coins 93 so that an update is made (S904). Meanwhile, in a case where the remaining delivering predetermined number 93 of 100 won coins has not been two or more, or in a case where the delivering possible number 92 of the 100W two-coin delivering tube 62 has not been two or more, the coin processing device 1 proceeds to the next processing without performing these pieces of processing.

Next, the coin processing device 1 determines whether the remaining delivering predetermined number 93 of 100 won coins has not been zero (S905). In a case where the remaining delivering predetermined number 93 of 100 won coins has been zero, the coin processing device 1 completes the 100W delivering-tube determining processing in the change-shortage state. In a case where the remaining delivering predetermined number 93 of 100 won coins has not been zero, the coin processing device 1 determines whether the remaining delivering predetermined number 93 of 100 won coins has been odd (S906). Here, in a case where the remaining delivering predetermined number 93 of 100 won coins has not been odd, namely, the remaining delivering predetermined number 93 of 100 won coins has been even, the 100W delivering-tube determining processing in the change-shortage is completed. Meanwhile, in a case where the remaining delivering predetermined number 93 of 100 won coins has been odd, the coin processing device 1 compares values of the delivering possible numbers 92 of the two 100W one-coin delivering tubes (the 100W one-coin delivering tube A 63, the 100W one-coin delivering tube B 65) (S907). In a case where the value of the 100W one-coin delivering tube A 63 is smaller, the 100W one-coin delivering tube A 63 is determined to be a coin tube 6 with which delivery of coins is performed in the following one time of delivering operation (pulling out and restoring the payout slide) (S908). In a case where both of the values are the same or the value of the 100W one-coin delivering tube B 65 is smaller, the 100W one-coin delivering tube B 65 is determined to be a coin tube 6 with which delivery of coins is performed in the following one time of delivering operation (pulling out and restoring the payout slide) (S910). Finally, the coin processing device 1 subtracts one from the value of the remaining delivering predetermined number 93 of 100 won coins so that an update is made (S909). The 100W delivering-tube determining processing in the change-shortage state is completed.

The above coin delivering device 1 according to the embodiment is capable of increasing the delivering processing of coins in speed.

The one embodiment of the present invention has been described above. The coin processing device according to the present invention is not limited to the embodiment. The above coin processing device according to the embodiment has the one two-coin delivering coin tube and the two one-coin delivering coin tubes, but may have two two-coin delivering coin tubes or more, or may have one one-coin delivering coin tube or three one-coin delivering tubes or more.

### REFERENCE SIGNS LIST

1 coin processing device
2 coin sorting device
3 coin delivering device
4 coin discriminating unit
5 coin distributing unit
6 coin tube
61 500W tube
62 100W two-coin delivering tube
63 100W one-coin delivering tube A
64 50W tube
65 100W one-coin delivering tube B
7 coin delivering unit
8 calculating unit
9 storing unit
91 increase-and-decrease counter
92 delivering possible number
93 remaining delivering predetermined number
10 completely-filled-state detecting switch
11 empty switch
12 empty-switch-state display LED
13 main control of vending machine or the like
C coin

1. A coin processing device comprising:
a coin discriminating unit configured to discriminate denominations of coins that have been inserted;
a coin distributing unit configured to distribute the coins that have been discriminated by the coin discriminating unit, each denomination;
a plurality of coin tubes for housing the coins that have been distributed by the coin distributing unit, each denomination; and
a coin delivering unit configured to deliver the coins that have been housed in the coin tubes, by delivering operation of pulling out by a payout slide,
wherein, for specific denominations, a two-coin delivering coin tube from which two coins are pulled out in one time of the delivering operation, and a one-coin delivering coin tube from which one coin is pulled out in one time of the delivering operation, are provided,
in a normal state where the coin housing number of the one-coin delivering coin tube is sufficient, the coin distributing unit distributes the specific denomination coins that have been inserted, to at least one of the coin tubes, the at least one having the coin housing number smaller, and the coin delivering unit delivers the specific denomination coins from at least one of the coin tubes, the at least one being selected in order to minimize the number of times of the delivering operation, and
in a change-shortage state where the coin housing number of the one-coin delivering coin tube is insufficient, the coin distributing unit preferentially distributes the specific denomination coins that have been inserted, to the one-coin delivering coin tube, and the coin delivering unit delivers as many of the specific denomination coins as possible from only the two-coin delivering coin tube.

2. A coin processing device comprising:
a coin discriminating unit configured to discriminate denominations of coins that have been inserted;
a coin distributing unit configured to distribute the coins that have been discriminated by the coin discriminating unit, each denomination;
a plurality of coin tubes for housing the coins that have been distributed by the coin distributing unit, each denomination; and
a coin delivering unit configured to deliver the coins that have been housed in the coin tubes, by delivering operation of pulling out by a payout slide,
wherein, for specific denominations, a two-coin delivering coin tube from which two coins are pulled out in one time of the delivering operation, and a one-coin delivering coin tube from which one coin is pulled out in one time of the delivering operation, are provided,
a two-coin delivering use mode in which the coin distributing unit performs distribution of coins to the two-coin delivering coin tube and the coin delivering unit performs delivery of coins from the two-coin delivering coin tube, and a two-coin delivering non-use mode in which the coin distributing unit does not perform distribution of coins to the two-coin delivering coin tube and the coin delivering unit does not perform delivery of coins from the two-coin delivering coin tube, are selectively performed, and
after power is turned on, the two-coin delivering non-use mode is selected, and when a command for delivering two or more coins is received, a switch to the two-coin delivering use mode is performed.

3. The coin processing device according to claim 1,
wherein the number of the one-coin delivering coin tube is two or more,
in the normal state, the coin distributing unit preferentially distributes the specific denomination coins that have been inserted, to at least one of the one-coin delivering coin tubes, the at least one having the coin housing number smaller, and the coin delivering unit preferentially delivers the specific denomination coins from at least one of the one-coin delivering coin tubes, the at least one having the coin housing number larger, and
in the change-shortage state, the coin distributing unit preferentially distributes the specific denomination coins that have been inserted, to at least one of the one-coin delivering coin tubes, the at least one having the coin housing number larger, and the coin delivering unit preferentially delivers the specific denomination coins from at least one of the one-coin delivering coin tubes, the at least one having the coin housing number smaller.

4. The coin processing device according to claim 1, further comprising a coin detecting unit configured to detect whether the coin housing number of each of the coin tubes has been a predetermined number or less,
wherein in a case where the coin detecting unit has not detected that the coin housing number of at least one of the one-coin delivering coin tubes has been the predetermined number or less, the normal state is made, and
in a case where the coin detecting unit has detected that the coin housing numbers of all of the one-coin delivering coin tubes have been the predetermined number or less, the change-shortage state is made.

5. The coin processing device according to claim 3, further comprising a coin detecting unit configured to detect whether the coin housing number of each of the coin tubes has been a predetermined number or less,
wherein in a case where the coin detecting unit has not detected that the coin housing number of at least one of the one-coin delivering coin tubes has been the predetermined number or less, the normal state is made, and
in a case where the coin detecting unit has detected that the coin housing numbers of all of the one-coin delivering coin tubes have been the predetermined number or less, the change-shortage state is made.
